(19) United States
(12) Patent Application Publication
(10) Pub. No.: US 2012/0045740 A1
(43) Pub. Date: Feb. 23, 2012

(54) NON-INVASIVE DETERMINATION OF NEUROTRANSMITTER INDICATION AND APPLICATIONS USING SAME

(76) Inventor: Paul J. Zak, Claremont, CA (US)

(21) Appl. No.: 13/216,014

(22) Filed: Aug. 23, 2011

Related U.S. Application Data
(60) Provisional application No. 61/375,990, filed on Aug. 23, 2010.

(51) Int. Cl. G09B 19/00

(52) U.S. Cl. 434/236

(57) ABSTRACT

An indication of a level of a neurotransmitter in an individual or for a group may be non-invasively determined. The neurotransmitter may be oxytocin. The determined indicator may be used to determine actions to increase effectiveness of an organization.

### CROSS REFERENCE TO RELATED APPLICATIONS

This application claims the benefit of the filing date of U.S. Provisional Patent Application No. 61/375,990, filed Aug. 23, 2010, the disclosure of which is incorporated by reference.

### BACKGROUND OF THE INVENTION

The present invention relates generally to brain chemical levels, and more particularly to non-invasively determining indications of a brain chemical level.

Many behavioral aspects of human interaction are influenced by brain chemicals levels, such as neurotransmitter levels. Levels of various chemicals within the brain may impact how individuals interpret intentions of other individuals in their surroundings. Some neurotransmitters may heighten anxiety, a possibly appropriate response to dangerous or unknown persons. Other neurotransmitters may heighten feelings of trust and well being, which may serve to facilitate group interaction.

One neurotransmitter, oxytocin, has been identified as generally increasing feelings of trust in individuals toward other individuals. Oxytocin is a peptide composed of nine amino acids and acts as a neurotransmitter within the brain, as well as a hormone when in the bloodstream. Exogenous administration of oxytocin has been found to be associated with an increase in trusting behavior in individuals. Certain behaviors, including trusting behavior, have been found to be associated with an increase in oxytocin release by the brain. Within the brain, oxytocin receptors are believed to be distributed in brain regions associated with behavior, particularly behavior related to promotion of social bonding.

Benefits of social bonding, in the form of individuals trusting one another, are believed to be apparent in many contexts. Levels of trust in strangers have been linked to financial well being of societies, with lower levels of trust, and concomitant reductions in financial transactions, resulting in decreased wealth. Similarly, lower levels of trust may also result in reduced organizational effectiveness.

Lack of organizational effectiveness may have many causes unrelated to trust, for example lack of necessary competence, lack of appropriate tools, or inappropriate goals. Identification of organizational dysfunction resulting from a lack of trust between individuals, among the panoply of possible causes, may therefore be difficult.

Measurement of oxytocin levels in individuals in an organization may provide an indication if reduced organization effectiveness is due to lack of trust within the organization. However, measurements of blood levels of oxytocin may be both difficult and expensive. Moreover, those subject to drawing of blood may consider the process overly invasive or worse, particularly if those subject to it are already mistrustful of the organization responsible for its occurrence. Further, actions to take based on measured levels of oxytocin may not be clear.

### BRIEF SUMMARY OF THE INVENTION

Aspects of the present invention provide for non-invasively determining a neurotransmitter level in an individual.

In some aspects the invention provides a method, performed using a processor configured by program instructions, of determining an indication of a neurotransmitter level of an individual, comprising: commanding presentation of questions to the individual relating to a social environment of the individual, each of the questions relating to at least one of the categories of: praise of the individual, anticipation of rewards by the individual, delegation of tasks to the individual, transparency of others perceived by the individual, empathy of others perceived by the individual, autonomy of the individual, and authenticity of others as perceived by the individual; receiving responses to the questions by the individual; assigning numerical values to each of the responses; and calculating a score based on the numerical values, the score being indicative of the neurotransmitter level of the individual.

In some aspects the invention provides a method of determining a level of trust within an organization based on non-invasive determination of an indication of levels of a neurotransmitter in individuals of the organization, comprising: presenting a plurality of questions to a plurality of members of the organization, the questions relating to extent of praise within the organization, extent of delegation within the organization, extent of transparency within the organization, extent of empathy within the organization, and extent of autonomy within the organization; and calculating a numerical value based on responses to the questions, the numerical value being indicative of levels of a neurotransmitter in individuals of the organization.

In some aspects the invention provides a method of increasing trust within an organization, comprising: presenting questions to members of the organization, the questions relating to extent of praise within the organization, extent of delegation within the organization, extent of transparency within the organization, extent of empathy within the organization, and extent of autonomy within the organization; calculating an indication of levels of oxytocin in the individuals based on responses to the questions; modifying application of a management technique; re-determining the indication of levels of the neurotransmitter in the individuals; and further modifying application of the management technique.

In some aspects the invention provides a method of optimizing organizational effectiveness within an organization based on non-invasive determination of a trust indicator in individuals of the organization, comprising presenting a plurality of questions to a plurality of individuals of the organization, the questions relating to a level of trust of the plurality of individuals towards other individuals within the organization, computing a score indicating the level of trust of the plurality of individuals based on responses to the questions; the score being indicative of levels of a neurotransmitter in the plurality of individuals; and selecting a management technique to implement based on the score.

These and other aspects of the invention are more fully comprehended upon review of this disclosure.

### BRIEF DESCRIPTION OF THE FIGURES

FIG. 1 is a flow diagram of a process for non-invasively determining an indication of a neurotransmitter level for an individual in accordance with aspects of the invention.

FIG. 2 is a semi-block diagram of a system for non-invasively determining an indication of a neurotransmitter level for an individual in accordance with aspects of the invention.

FIG. 3 is a flow diagram of a process for increasing a neurotransmitter level in individuals within an organization.

FIG. 4 is a flow diagram of a process for optimizing organizational effectiveness within an organization.

### DETAILED DESCRIPTION

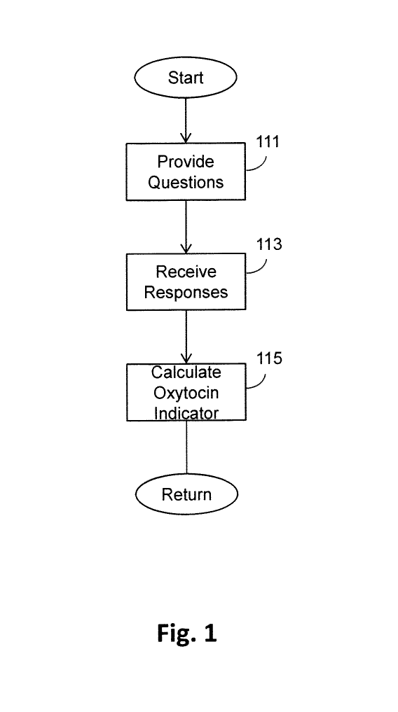

FIG. 1 is a flow diagram of a process in accordance with aspects of the invention. The process of FIG. 1 may be used, for example, to non-invasively determine an indication of a neurotransmitter level for an individual. In the example process of FIG. 1 the neurotransmitter is oxytocin, a neurotransmitter believed to be generally associated with an individual's feelings of trust towards others. Thus, the level of trust of an individual towards others, for example as reflected in the answers the individual provides to questions relating to a social environment, can provide an indication of the oxytocin level in the individual.

In block 111 the process provides questions to be presented to an individual, and in some embodiments presents the questions to the individual. The questions relate to a social environment of the individual, for example a social group. In some embodiments the social group is a business organization. In most embodiments the questions relate to extent of the individual's trust in others within the social group, and extent of the others' trust in the individual as perceived by the individual. In some embodiments the questions relate to the individual's perception of esteem of the individual held by the others, the openness of the others as perceived by the individual, and autonomy felt by the individual.

In one embodiment each of the questions relate to one or more of 1) extent of recognition by others of excellence of the individual as perceived by the individual. 2) extent of delegation of tasks by others to the individual as perceived by the individual, 3) extent of transparency of others as perceived by the individual, 4) extent of empathy by others perceived by the individual, 5) extent of autonomy provided by others to the individual as perceived by the individual, and 6) extent of authenticity of others as perceived by the individual. In addition, in some embodiments, at least some questions relate to extent of availability of rewards as perceived by the individual and/or the novelty of the rewards as perceived by the individual.

In some embodiments the questions allow for a predefined range of responses. For example, in some embodiments a question may be answered with any of five predefined responses or, for example, any of 10 predefined responses. Conveniently, the questions may ask for responses to statements, and the predefined range of responses may reflect extent of agreement or disagreement with the statements.

In such embodiments a plurality of statements relating to, for example each of the six categories listed above may be presented to the individual, with some of the statements reflective of greater extents and some of the statements reflective of lesser extents. The statements reflective of greater extents may be considered positive questions and the statements reflective of lesser extents may be considered negative questions.

In block 113 the process receives responses to the questions from the individual. The responses from the individual can be correlated with a brain chemical level, for example a neurotransmitter level, of the individual.

In block 115 the process calculates an indication of a brain chemical level, for example a brain neurotransmitter level, of the individual. In some embodiments the brain neurotransmitter is oxytocin. In some embodiments, for example those in which a range of numerical values are assigned to each possible answer for each question, the indication of oxytocin level is a normalized average of the sum of the numerical values of the responses. For embodiments in which the questions include positive questions and negative questions, the indication of oxytocin level may be a normalized average of the sum of numerical values of the responses to the positive questions minus the sum of the numerical values assigned to responses to negative questions. For example, if the numerical values are integers that range from 1 to 10, the indication of oxytocin level may be determined as equal to (P−N)/(10*T), where P is the sum of values for positive questions, N is the sum of values for negative questions, and T is the total number of questions. In addition, it may be appropriate to limit the indication of oxytocin level to non-negative numbers, such that the indication of oxytocin level is equal to max((P−N)/(10*T),0).

In addition, in some embodiments values may be determined for each category of questions. For example, values for each of the categories of empathy, delegation, praise, authenticity, autonomy, transparency, and anticipation may be determined, for example as discussed above with respect to determination of brain chemical levels, for example oxytocin.

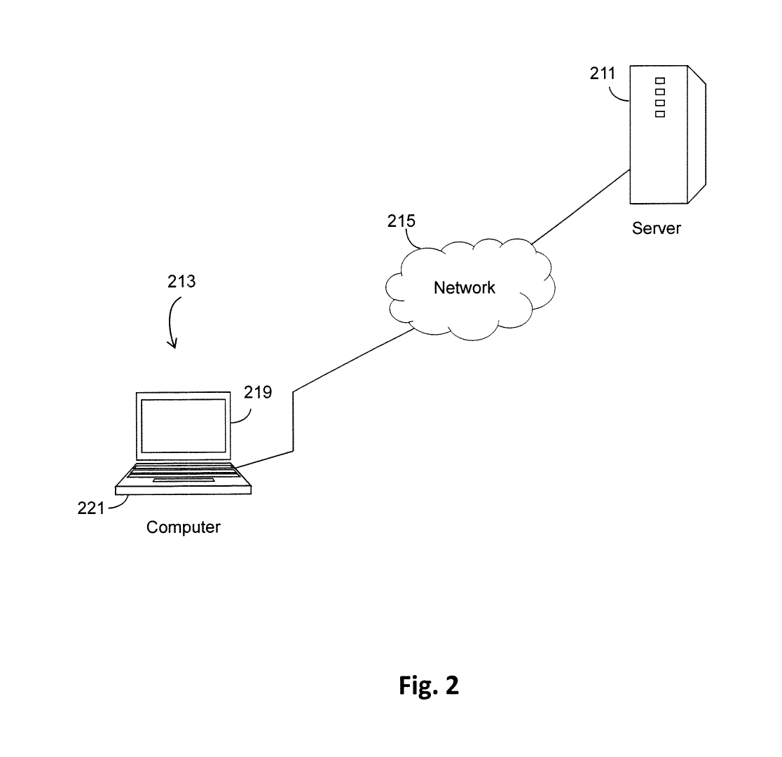

FIG. 2 is a semi-block diagram of a system for non-invasively determining an indication of a neurotransmitter level in an individual. In some embodiments the neurotransmitter is oxytocin.

The system includes a server 211. The server generally includes one or more processors, which in some embodiments may be implemented by use of processor cores, and associated circuitry, memory and other items generally associated with servers. The server is configured, for example by way of program instructions, to provide question information, receive information of responses to the question information, and to determine an indication of a neurotransmitter level in an individual based on the information of responses. The question information may be the questions discussed with respect to FIG. 1.

For example, in some embodiments the server is configured by program instructions, to retrieve question information from memory and to transmit or cause transmission of the question information over a communications network 215 to a computer 213.

The computer 213 includes a display device 219 and an input device 221, shown in FIG. 2 as a keyboard, in addition to one or more processors and other circuitry generally associated with computers. The processor is configured by program instructions to command presentation of the questions to an individual and to receive responses to the questions and to transmit or cause transmission of the responses to the server. In some embodiments, however, the computer may be configured to perform functions of the server, and the system may comprise the computer.

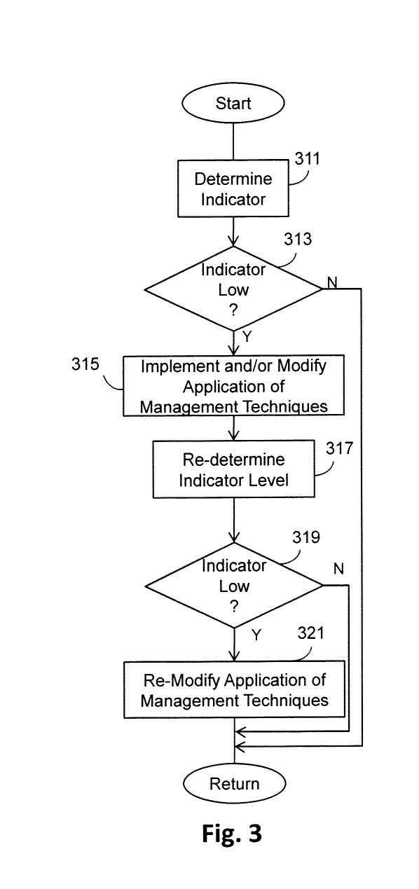

FIG. 3 is a flow diagram of a process for increasing trust within an organization. In block 311 the process determines an indicator of a neurotransmitter level for individuals in a group within the organization. In some embodiments the process determines the indicator of a neurotransmitter level as variously discussed with respect to FIGS. 1 and 2 for each of the individuals in a group, or a sampling of individuals in the group. In some embodiments the neurotransmitter is oxytocin.

In block 313 the process determines if the indicator in an individual or a sub-group of individuals is lower than desired. In some embodiments the process determines if the indicator in the individual is lower than desired by comparing it to an average, a mean, or, in some embodiments, a median, of a normalized value of the indicator for all of the individuals for which the indicator was determined. In addition or instead, in some embodiments the process identifies individuals for whom the value of the indicator is a predetermined or a determined amount, such as a standard deviation, below the average, mean, or median value of the indicator for all the individuals. In some such embodiments, reasons for the lower indicator values may be investigated, for example by way of interviews or examination of job history, which may include management history and task involvement history, or the like. Preferably the investigation is directed to determining if the lower indicator value for an individual or sub-group of individuals is related to one or more common causes, which may be corrected.

In block 315 the process selects, implements and/or modifies application of one or more management techniques for increasing the indicator of the neurotransmitter level. In some embodiments the technique is one or more of 1) praise. 2) delegation, 3) transparency. 4) empathy, 5) autonomy. 6) authenticity, and 7) anticipation.

In some embodiments, the praise technique comprises for example acknowledging, recognizing or rewarding an achievement or positive behavior of an individual or a subgroup of individuals. In some embodiments, the anticipation technique comprises for example offering immediate rewards when goals are reached. In some embodiments, the delegation technique comprises for example distributing tasks to an individual or a subgroup of individuals that are within their realm of interest and expertise. In some embodiments, the transparency technique includes for example encouraging open communication between individuals and their supervisors. In some embodiments, the empathy technique comprises for example being responsive to an individual or a subgroup of individuals' needs. In some embodiments, the autonomy technique includes for instance giving an individual or a sub group of individuals greater independence in their work. In some embodiments, the authenticity technique includes practicing the above discussed six techniques authentically to improve the work lives of an individual or a subgroup of individuals.

In some embodiments, however, the technique is some or all of the listed techniques. In some embodiments, one or more of the listed techniques is selected and implemented.

In block 317 the process re-determines the indicator of the neurotransmitter level for the individual or the subgroup of individuals following the implementation and/or modification of the one or more selected techniques. In some embodiments, the neurotransmitter is oxytocin. In some embodiments, indicator values may be determined for each of the categories of praise, anticipation, delegation, transparency, empathy, autonomy, and authenticity as discussed above with respect to determination of brain chemical levels, for example oxytocin. In some embodiments, the results are also determined for some or all of questions relating to these techniques, and the selected technique is the technique or techniques which produces for example a most significant increase in the indicator of the oxytocin level.

In block 319, the process determines if the indicator level is sufficiently improved by the implemented technique or techniques.

If the indicator level is considered insufficiently improved by the implemented technique or techniques, in block 321 the process modifies application of one or more management techniques. For example, modification of the praise technique may comprise increasing rewards to those in the organization, either in quantity of rewards or quality of rewards. The rewards in some embodiments are monetary or tangible, but in various embodiments the rewards need not be. Instead, the rewards may be, for example, verbal in nature. In some embodiments modification of the praise technique may be the encouragement of praise by those in various levels of management, or even (or especially) by those not in management. Thus, in some embodiments modification of the praise technique may be to increase rewards for praising others. In addition, in some embodiments, modification of the praise technique may be to reduce dissemination of knowledge amongst others of corrective actions taken towards a member of the organization.

As another example, modification of the delegation technique may be to increase numbers of tasks delegated within the organization, particularly from a more senior member of the organization to a more junior member of the organization. Modification of the delegation technique may also or instead comprise providing additional support or resources to those delegated tasks.

As yet another example, modification of the transparency technique may comprise increasing the quantity and/or quality of information provided to members of the organization, particularly more junior members of the organization. As yet a further example, modification of the empathy technique may be to encourage members of the organization to more attentively listen to other members of the organization, particularly those more junior in the organization than themselves, or to spend more time listening to the others. As another example, modification of the autonomy technique may comprise reducing frequency of monitoring of those delegated tasks and/or decreasing extent of monitoring of those delegated tasks.

The process thereafter returns. In many embodiments the process is repeatedly performed.

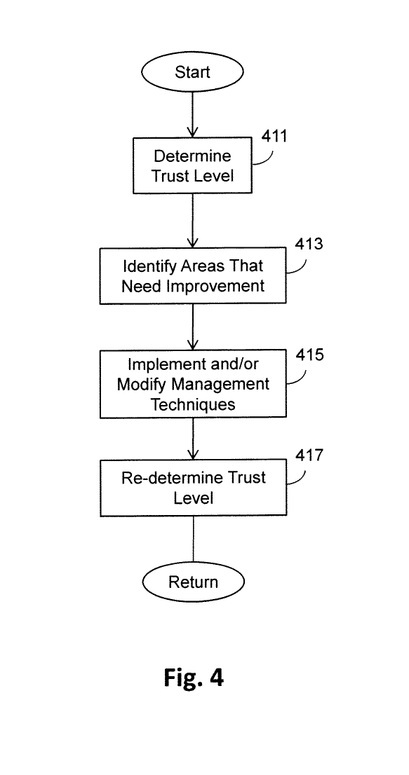

FIG. 4 is a flow diagram of a process for optimizing organizational effectiveness within an organization. In block 411 the process determines a level of trust of individuals or subgroups of individuals towards other members within the organization. In some embodiments the process determines an indicator of the level of trust or trust indicator. In some embodiments, the trust indicator is an indicator for a neurotransmitter level as variously discussed with respect to FIGS. 1, 2 and 3 for each of the individuals or subgroups in the organization, or a sampling of individuals or subgroups in the organization. In some embodiments, the neurotransmitter is oxytocin.

In some embodiments, as previously discussed with respect to FIG. 1, determining an indicator for the neurotransmitter level comprises providing questions to be presented to the individuals or the subgroups, receiving responses to the questions by the individuals or the subgroups; assigning numerical values to the responses and calculating a score based on the numerical values, the scores being indicative of neurotransmitter level of the individuals or the subgroups.

In block 413, the process identifies areas that need improvements. In some embodiments the process determines if the trust indicator of an individual or subgroup is lower than an average, a mean, or, in some embodiments, a median, of a normalized value of the trust indicator for all of the individuals or subgroups for which the trust indicator was determined. In some embodiments, reasons for the lower trust indicator values of the individuals or subgroups may be investigated, for example by way of interviews or examination of job history, which may include management history and task involvement history, or the like. Preferably the investigation is directed to determining if the lower trust indicator value for individuals or subgroups of individuals can be related to one or more common causes, which may be corrected, as previously discussed with respect to FIG. 3.

In block 415, the process selects one or more management techniques for implementation and/or modification. In some embodiments, the management techniques comprise one of or a combination of the techniques discussed with respect to FIGS. 1, 2 and 3.

In block 417, the process re-determines the trust indicator of the individuals or subgroups of individuals. The process can be repeated as often as needed until a targeted trust indicator is achieved.

Aspects of the invention therefore provide for non-invasive determination of an indication of a neurotransmitter level for an individual, and for increasing neurotransmitter levels of individuals within an organization. Although the invention has been discussed with respect to specific embodiments, it should be understood that the invention comprises the novel and non-obvious claims and their insubstantial variations supported by this disclosure.

What is claimed is:

1. A method, performed using a processor configured by program instructions, of determining an indication of a neurotransmitter level of an individual, comprising:
commanding presentation of questions to the individual relating to a social environment of the individual, each of the questions relating to at least one of the categories of: praise of the individual, anticipation of rewards by the individual, delegation of tasks to the individual, transparency of others perceived by the individual, empathy of others perceived by the individual, autonomy of the individual, and authenticity of others as perceived by the individual;
receiving responses to the questions by the individual;
assigning numerical values to each of the responses; and
calculating a score based on the numerical values, the score being indicative of the neurotransmitter level of the individual.

2. The method of claim 1, wherein the neurotransmitter is oxytocin.

3. The method of claim 1 wherein the questions include questions relating to each of the categories.

4. The method of claim 1 wherein each of the questions have a finite number of possible responses.

5. The method of claim 4 wherein each of the finite number of possible responses have an assigned numerical value.

6. The method of claim 5 wherein assigning numerical values to each of the responses comprises assigning the assigned numerical value of a selected response of the possible responses to the response.

7. The method of claim 6 wherein each of the questions is defined as either a positive question or as a negative question.

8. The method of claim 7 wherein calculating the score comprises determining a normalized average of the sum of numerical values assigned to responses to positive questions minus the sum of numerical values assigned to responses to negative questions.

9. A method of determining a level of trust within an organization based on non-invasive determination of an indication of levels of a neurotransmitter in individuals of the organization, comprising:
presenting a plurality of questions to a plurality of members of the organization, the questions relating to extent of praise within the organization, extent of delegation within the organization, extent of transparency within the organization, extent of empathy within the organization, and extent of autonomy within the organization; and
calculating a numerical value based on responses to the questions, the numerical value being indicative of levels of a neurotransmitter in individuals of the organization.

10. A method of increasing trust within an organization, comprising:
presenting questions to members of the organization, the questions relating to extent of praise within the organization, extent of delegation within the organization, extent of transparency within the organization, extent of empathy within the organization, and extent of autonomy within the organization;
calculating an indication of levels of a neurotransmitter in the individuals based on responses to the questions;
modifying application of a management technique;
re-determining the indication of levels of the neurotransmitter in the individuals; and
further modifying application of the management technique.

11. The method of claim 10, wherein the neurotransmitter is oxytocin.

12. The method of claim 10, wherein calculating the indication of levels of the neurotransmitter comprises assigning numerical values to each of the responses to the questions.

13. The method of claim 12, wherein the questions have a finite number of possible responses.

14. The method of claim 13, wherein each of the finite number of possible responses has an assigned numerical value.

15. The method of claim 14, wherein assigning numerical values to each of the responses comprises assigning the assigned numerical value of a selected response of the possible responses to the response.

16. The method of claim 15, wherein each of the questions is defined as either a positive question or as a negative question.

17. The method of claim 15, wherein calculating the indication of levels of the neurotransmitter comprises determining a normalized average of the sum of numerical values assigned to responses to positive questions minus the sum of numerical values assigned to responses to negative question.

18. The method of claim 10, wherein the management technique comprises at least one of the categories of: praise, anticipation, delegation, transparency, empathy, autonomy, and authenticity.

19. A method of optimizing organizational effectiveness within an organization based on non-invasive determination of a trust indicator in individuals of the organization, comprising:
presenting a plurality of questions to a plurality of individuals of the organization, the questions relating to a level of trust of the plurality of individuals towards other individuals within the organization;
computing a score indicating the level of trust of the plurality of individuals based on responses to the questions; the score being indicative of levels of a neurotransmitter in the plurality of individuals; and
selecting a management technique to implement based on the score.

20. The method of claim 19, wherein the plurality of questions relate to extent of praise within the organization, extent of rewards within the organization, extent of delegation within the organization, extent of transparency within the organization, extent of empathy within the organization, and extent of autonomy within the organization.

21. The method of claim 19, wherein the neurotransmitter is oxytocin.
